(19) United States
(12) Patent Application Publication
(10) Pub. No.: US 2006/0046131 A1
(43) Pub. Date: Mar. 2, 2006

(54) Fuel cell apparatus improvements

(75) Inventors: David Frank, Scarborough (CA); Nathaniel Ian Joos, Toronto (CA); Mario Dzamarija, Toronto (CA); Raymond Candido, Toronto (CA); Antonio Gennaro Mazza, Whitby (CA)

Correspondence Address: BERESKIN AND PARR, 40 KING STREET WEST, BOX 401, TORONTO, ON, M5H 3Y2, CA

(73) Assignee: Hydrogenics Corporation, Mississauga (CA)

(21) Appl. No.: 10/926,107

(22) Filed: Aug. 26, 2004

(51) Int. Cl. H01M 8/02; H01M 8/10; H01M 4/94

(52) U.S. Cl. 429/38; 429/44; 429/30

(57) ABSTRACT

An electrochemical cell assembly with structural improvements for improving cell operation. The electrochemical cell assembly may include at least one of an extended MEA and chamfered edges on the flow field plates for preventing the shorting of the anode and cathode flow field plates. Further, the flow field plates may include a pocket for providing an appropriate space to accommodate a gas diffusion media and applying an appropriate amount of compression to the gas diffusion media.

### FIELD OF THE INVENTION

This invention relates to electrochemical cells such as fuel cells and electrolyzer cells. In particular, this invention relates to improvements in the structure of fuel cell components.

### BACKGROUND OF THE INVENTION

Fuel cells are used to generate electrical energy using various fuels, whilst electrolyzer cells are used to generate hydrogen gas from hydrogen containing fuels. One form of fuel cell that is currently believed to be practical for usage in many applications is a fuel cell employing a proton exchange membrane (PEM). A PEM fuel cell enables a simple, compact fuel cell to be designed, which is robust, which can be operated at temperatures not too different from ambient temperatures and which does not have complex requirements with respect to fuel, oxidant and coolant supplies.

Conventional fuel cells generate relatively low voltages. In order to provide a useable amount of power, fuel cells are commonly configured into fuel cell stacks, which typically may have 10, 20, 30 or even hundreds of fuel cells in a single stack. While this does provide a single unit capable of generating useful amounts of power at usable voltages, the design can be quite complex and can include numerous elements, all of which must be carefully assembled.

For example, a conventional PEM fuel cell requires two flow field plates, an anode flow field plate and a cathode flow field plate. A membrane electrode assembly (MEA), including the actual PEM is provided between the two plates. Additionally, a gas diffusion media (GDM) is provided, sandwiched between each flow field plate and the PEM. The GDM enables diffusion of an appropriate gas, either the fuel or oxidant, to the surface of the PEM, and at the same time provides for conduction of electricity between the associated flow field plate and the PEM.

This basic cell structure itself requires two seals, each seal being provided between one of the flow field plates and the PEM. Moreover, these seals have to be of a relatively complex configuration. In particular, as detailed below, the flow field plates, for use in the fuel cell stack, have to provide a number of functions and a complex sealing arrangement is required. The seals can be provided by gaskets or by a sealant material via a seal-in-place process.

For a fuel cell stack, the flow field plates typically provide apertures or openings at either end, so that a stack of flow field plates then define elongate channels extending perpendicularly to the flow field plates. As a fuel cell requires flows of a fuel, an oxidant and a coolant, this typically requires three pairs of ports or six ports in total for a fuel cell with three ports for each flow field plate. This is because it is necessary for the fuel and the oxidant to flow through each fuel cell. A continuous flow through the fuel cell ensures that, while most of the fuel or oxidant (as the case may be) is consumed, any contaminants are continually flushed through the fuel cell.

The foregoing assumes that the fuel cell would be a compact type of configuration provided with water or the like as a coolant. Consequently, each flow field plate typically has three apertures at each end, each aperture representing either an inlet or outlet for one of fuel, oxidant and coolant. In a completed fuel cell stack, these apertures align, to form distribution channels extending through the entire fuel cell stack. It will thus be appreciated that the sealing requirements are complex and difficult to meet. However, it is possible to have multiple inlets and outlets to the fuel cell for each fluid depending on the stack/cell design.

The coolant commonly flows across the back of each fuel cell, so as to flow between adjacent, individual fuel cells. This is not essential however and, as a result, many fuel cell stack designs have cooling channels only at every 2nd, 3rd or 4th (etc.) plate. This allows for a more compact stack (thinner plates) but may provide less than satisfactory cooling. In addition, this configuration requires another seal, namely a seal between each adjacent pair of individual fuel cells.

A fuel cell stack, after assembly, is commonly clamped to secure the elements of the fuel cell stack and ensure that adequate compression is applied to the seals and active area of the fuel cell stack. This method ensures that the contact resistance is minimized and the electrical resistance of the fuel cells is at a minimum. To this end, a fuel cell stack typically has two substantial end plates, which are configured to be sufficiently rigid so that their deflection under pressure is within acceptable tolerances. The fuel cell stack also typically has current bus bars to collect and concentrate the current from the fuel cell stack to a small pick up point and the current is then transferred to the load via conductors. Insulation plates may also be used to provide thermal and electrical isolation for the current bus bars and the endplates from each other. A plurality of elongated tension rods, bolts and the like are then provided between the pairs of endplates, so that the fuel cells between the endplates can be clamped together. Rivets, straps, piano wire, metal plates and other mechanisms can also be used to clamp the fuel cell stack together. To assemble the fuel cell stack, the tension rods are provided extending through one of the endplates, an insulator plate and then a bus bar (including seals) are placed on top of the endplate, and the individual elements of the fuel cell are then built up within the space defined by alignment rods or by some other positioning tool.

A problem in many electrochemical cell designs is that each individual flow field plate is relatively fragile, since it is necessarily made from an electrical conductive material such as graphite. The flow field plate is thus prone to bending during the assembly process. In addition, with the use of a seal-in-place process, the spacing between the flow field plates is reduced because sealant material is used rather than a gasket. Accordingly, when either of the flow field plates, for a particular fuel cell, gets slightly bent in the assembly process or during regular use, the probability that the edges of the flow field plates will touch each other resulting in a short increases. Shorting may also arise when gaskets are used, since the gasket may shift position during assembly or use or the gasket may become over-compressed. Shorting is not desirable, since a short will reduce the electrical energy generation of the fuel cell stack as well as possibly damage one or more of the components of the fuel cell stack. The shorting of the flow field plates may also contribute to faster degradation of the fuel cell and a subsequent reduction in the lifetime of the fuel cell. Needless to say, such an event also increases the amount of maintenance that must be performed on the fuel cell stack.

Furthermore, the gas flow and electrical conductivity properties of the GDM are important since these properties affect cell operation. Both of these properties can vary due to the amount of compression that is experienced by the GDM. Accordingly, it is important to ensure that each cell has appropriate structural features to ensure that the GDM experiences an appropriate amount of compression.

### SUMMARY OF THE INVENTION

The inventors have made several structural improvements to the components of a fuel cell that can be used in isolation or in combination, to address one or more of the above-noted shortcomings and to improve the operating efficiency of a fuel cell. In one instance, the inventors have found that it is advantageous to increase the surface area of the MEA relative to the surface area of the flow field plates. In this case, during fuel cell assembly or maintenance, if the flow field plates of a given fuel cell bend, due to stress, the flow field plates will advantageously touch the MEA rather than touch each other which will prevent electrical shorting. The extended MEA may include alignment notches in certain locations if alignment rods are used during fuel cell stack assembly.

In an alternative, that can be practiced in combination or instead of the extension of the MEA surface area, the inventors have found that it is advantageous to chamfer the edges of the flow field plates. The inventors have found that using chamfered edges reduces the chance that the flow field plates of a given fuel cell will short if one or more of the flow field plates bend. The edges of the flow field plate may be chamfered by making a straight cut at a desired angle (this is referred to as a straight chamfer). Alternatively, the edges of the flow field plate may be chamfered by making a round cut using a desired radius of curvature (this is referred to as a round chamfer).

The inventors have also found that it is beneficial to monitor GDM thickness, and the compression pressure that is applied to the GDM during fuel cell assembly. In particular, the inventors have found that it is beneficial to maintain a certain amount of compression on the GDM by selecting an appropriate depth for a GDM pocket or GDM depression in the flow field plates within which the GDM resides. The inventors have found that it is beneficial to maintain the GDM pocket at a depth that is related to a percentage of the uncompressed GDM thickness.

In a first aspect, the invention provides an electrochemical cell assembly comprising first and second flow field plates each including an active surface facing one another and having a first surface area; first and second gas diffusion media disposed between the first and second flow field plates; and, a membrane electrode assembly disposed between the first and second gas diffusion media with first and second surfaces each having a second surface area larger than the first surface area, and having at least a portion extending beyond the perimeter of the first and second flow field plates.

In another aspect, the invention provides an electrochemical cell assembly comprising first and second flow field plates, each including an active surface facing one another; first and second gas diffusion media disposed between the first and second flow field plates; and, a membrane electrode assembly disposed between the first and second gas diffusion media, wherein the active surface of at least one of the flow field plates includes at least one outer chamfered edge.

In yet another aspect, the invention provides an electrochemical cell assembly comprising first and second flow field plates each including an active surface facing one another having a first surface area, the first and second flow field plates having a first set of apertures for reactant gas flow and optionally coolant flow; first and second gas diffusion media disposed between the first and second flow field plates; and, a membrane electrode assembly disposed between the first and second gas diffusion media with first and second surfaces each having a second surface area larger than the first surface area, and having at least a portion extending beyond the perimeter of the first and second flow field plates, and wherein the membrane electrode assembly has a second set of apertures corresponding to the first set of apertures, wherein at least some inner edges of the apertures in the second set of apertures extend beyond the corresponding inner edges of the apertures in the first set of apertures.

In another aspect, the invention provides a flow field plate for an electrochemical cell assembly, the flow field plate having an active surface, and apertures for reactant gas flow and optionally coolant flow, wherein the active surface has at least one outer chamfered edge and at least one of the apertures has at least one inner chamfered edge.

### BRIEF DESCRIPTION OF THE DRAWINGS

For a better understanding of the invention and to show more clearly how it may be carried into effect, reference will now be made to the accompanying drawings which show, by way of example, embodiments of the invention and in which:

FIG. 1a is a cross-sectional front view of the structure of an exemplary fuel cell assembly;

FIG. 1b is a magnified view of the fuel cell assembly of FIG. 1a showing a case of flow field plate bending;

FIG. 2a is a cross-sectional front view of an exemplary embodiment of a fuel cell assembly incorporating an extended MEA in accordance with the invention;

FIG. 2b is a top view of the extended MEA of FIG. 2a;

FIG. 2c is a bottom view of the extended MEA of FIG. 2b;

FIG. 2d is a magnified view of the fuel cell assembly of FIG. 2a showing a-case of flow field plate bending;

FIG. 3a is a cross-sectional front view of another exemplary embodiment of a fuel cell assembly with flow field plates having chamfered edges in accordance with the invention;

FIG. 3b is a magnified view of the edge of a flow field plate having a straight-chamfered edge;

FIG. 3c is a magnified view of the edge of a flow field plate having a round-chamfered edge;

FIG. 3d is a magnified view of the fuel cell assembly of FIG. 3a showing a case of flow field plate bending;

FIG. 4 is a cross-sectional front view of another exemplary embodiment of a fuel cell assembly incorporating an extended MEA and flow field plates with chamfered edges in accordance with the invention; and,

FIG. 5 is a partial cross-sectional view of a flow field plate having a GDM pocket with an appropriate depth for receiving a GDM in accordance with the invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures and components have not been described in detail so as not to obscure the invention. Further, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

There are various known types of electrochemical cells. Examples of such cells currently receiving great interest in the industry are fuel cells and electrolyzer cells. The description below will exemplify a fuel cell. However, the general principles of the invention apply to all electrochemical cells.

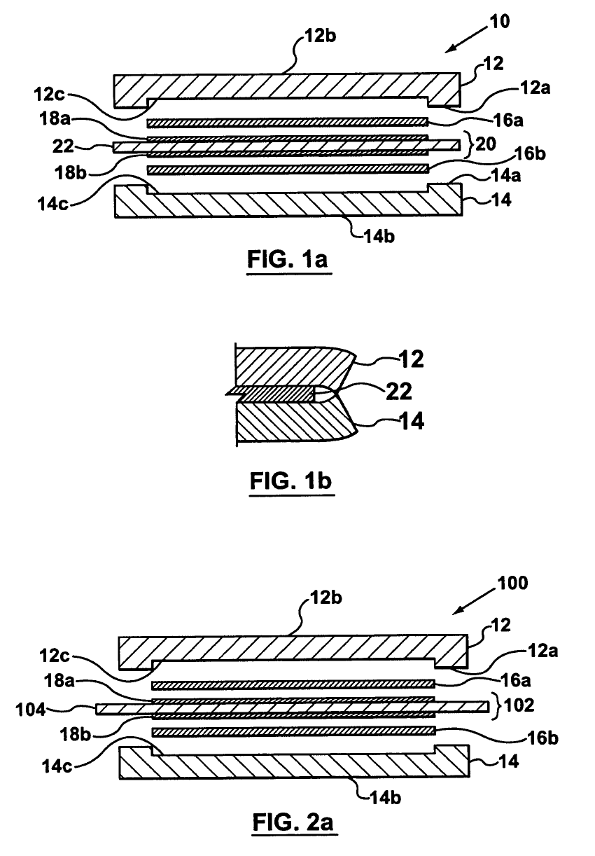

Referring now to FIG. 1, shown therein is an exemplary embodiment of an electrochemical cell assembly 10 commonly known in the art. The electrochemical cell assembly 10 comprises a first flow field plate 12 and a second flow field plate 14, which are respectively anode and cathode flow field plates. The flow field plates 12 and 14 each have an active surface 12b and 14a and a passive surface 12a and 14b respectively.

The electrochemical cell assembly 10 further includes a membrane electrode assembly (MEA) 20 sandwiched between the flow field plates 12 and 14. As in conventional fuel cells, the MEA 20 is considered to comprise a total of three layers, namely: a central proton exchange membrane layer (PEM) 22 and catalyst layers 18a and 18b on either side of the PEM 22 to promote the necessary reaction to generate electricity. The central PEM layer 22 is typically made from a proton conducting material, such as a polymer or an ionomer, that permits protons to pass through but not electrons. Generally, any suitable polymer or ionomer material, as is known by those skilled in the art, may be used as the PEM layer 22. The PEM layer 22 may also include sub-gaskets (not shown), as is commonly known by those skilled in the art, which are used to provide structural support and to increase the durability of the MEA 20. The sub-gaskets may also be used to provide extra sealing as well. Some possible locations for the sub-gaskets on the MEA 20 are around the catalyst layout (not shown) such that the sub-gaskets are situated around portions of the perimeter of the gas diffusion media when the electrochemical cell assembly 10 is assembled. There may also be other materials added to the catalyst layers 18a and 18b as is commonly known by those skilled in the art.

There are also two layers of gas diffusion media (GDM) 16a and 16b located on either side of the PEM 22 abutting the catalyst layers 18a and 18b. The GDMs 16a and 16b are usually maintained pressed against the catalyst layers to ensure adequate electrical conductivity and reactant gas access to the catalyst layers 18a and 18b on the MEA 20. However, the two GDMs 16a and 16b are not considered to be part of the MEA 20 itself. The GDMs 16a and 16b are usually made from porous, conductive carbon-based materials. The most commonly used materials are carbon paper, and carbon cloth with a bonded layer of carbon powder.

The flow field plates 12 and 14 also have reactant gas flow channels (not shown) arranged on their active surfaces 12a and 12b to provide reactant gas flow to the GDMs 16a and 16b which in turn provide the reactant gas flow to the MEA 20 for reaction. The passive surfaces 12b and 14b of the flow field plates 12 and 14 may also have coolant channels along which coolant fluid may be passed to cool the electrochemical cell assembly 10.

In addition, although not shown in FIG. 1a, it is generally understood that it is common practice to manufacture the flow field plates 12 and 14 such that they include a GDM pocket 12c and 14c on their active surfaces 12b and 14b. The pocket is sized to accommodate the GDM 16. This is described in further detail below. However, there may also be some cases in which the GDM 16 extends all the way to the edges of the flow field plates 12 and 14 as shown in FIG. 1 in which case the pocket is not needed. Accordingly, it should be understood by those skilled in the art that, while it may be common practice to employ a GDM pocket, the pocket may not be necessary for certain aspects and embodiments of the invention. Further, previously, those skilled in the art did not consider how to select an appropriate depth for the GDM pocket.

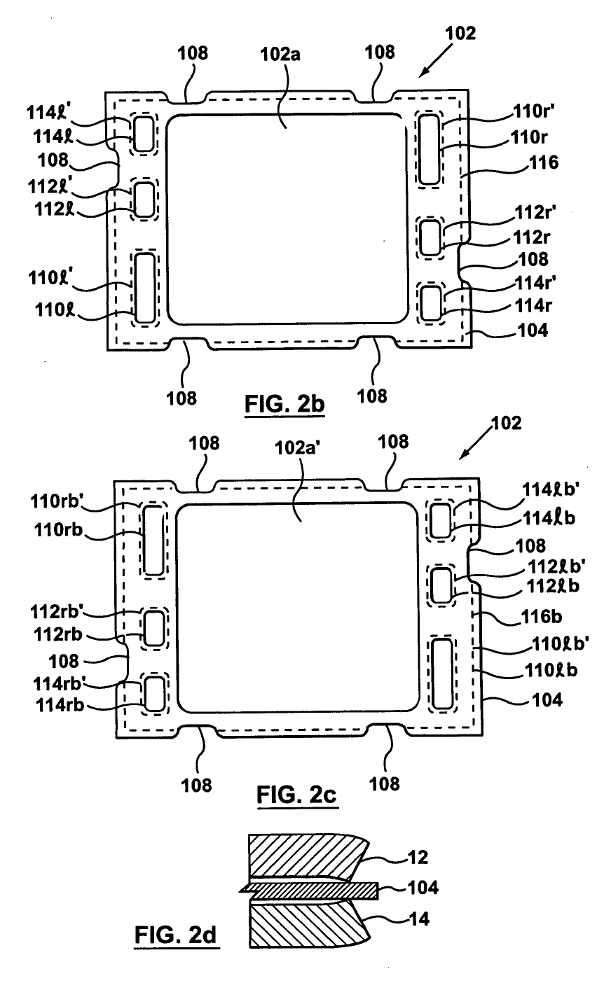

The various components of the electrochemical cell assembly 10 are attached to each other in known manner. For instance, there may be gaskets that are used to provide a seal between the various components of the electrochemical cell assembly 10 and the flow field plates 12 and 14 are secured to one another to ensure that the interior components are held in place under sufficient compression. Alternatively, a seal-in-place procedure may be used, rather than gaskets, to seal the various components of the electrochemical cell assembly. An example of a seal-in place procedure that may be used is described in co-pending U.S. patent application Ser. No. 09/854,362 which is hereby incorporated by reference. The MEA 20 may be manufactured to have similar dimensions (i.e. surface area) compared with the flow field plates 12 and 14 as shown in FIG. 1. Alternatively, the MEA 20 may have slightly smaller dimensions compared with the flow field plates 12 and 14 and a gasket may be placed around the outer edges of the MEA 20 and the inner edges of the MEA 20 around the port apertures (see FIGS. 2b and 2c for an example of the port apertures).

However, the MEA 20 is very thin, and may never be perfectly aligned with the flow field plates 12 and 14 because of differences in dimensions due to manufacturing tolerances. There may also be positioning errors during the fuel cell assembly process. Alternatively, or in addition to these issues, imperfections in the flow field plates 12 and 14, the MEA 20 or in the gaskets or seal-in place process (depending on which type of sealing is used), may also increase the likelihood that the plates 12 and 14 will contact one another at their edges. Furthermore, if sealant material is used rather than a gasket, the spacing between the flow field plates 12 and 14 is reduced which increases the chances that the plates 12 and 14 may touch one another.

Referring now to FIG. 1b, shown therein is a magnified view of the electrochemical cell assembly 10 showing a case in which the flow field plate 12 and 14 are bending towards one another. In this case, the flow field plates 12 and 14 touch one another since the MEA 20 does not extend to the edges of the flow field plates 12 and 14 (this may occur for any of the reasons mentioned above). Consequently, there is an electrical short for the electrochemical cell assembly 10. It should also be noted that the MEA 20 is quite thin, sometimes being on the order of 1 to 3 thou. This dimension is quite small in comparison to the thickness of the flow field plates 12 and 14 which may be on the order of 40 to 60 thou. Accordingly, it may be difficult for a conventional MEA 20 to provide a separation between two flow field plates 12 and 14.

Referring now to FIG. 2a, shown therein is an electrochemical cell assembly 100 constructed in accordance with the invention. The electrochemical cell assembly 100 includes all of the components of the electrochemical cell assembly 10 with the exception of a modified MEA 1.02. In particular, the MEA 102 has been modified by increasing the size of the PEM 104 such that the surface area of the MEA 102 is larger than the surface area of the flow field plates 12 and 14. Although not shown in FIG. 2a, the increase in the size of the PEM 104 may also be accompanied with an increase in the size of the catalyst layers 18a and 18b. Further, the MEA 102 may be situated relative to the flow field plates 12 and 14 such that at least two of the edges of the MEA 102 extends beyond the edges of the flow field plates 12 and 14. The main purpose for the extension of the MEA 102 is to prevent shorting of the flow field plates 12 and 14. The extension of the MEA 102 may occur in two or more directions and may extend for a pre-determined length beyond the perimeter of the flow field plates 12 and 14.

Referring now to FIGS. 2b and 2c, shown therein are top and bottom views of the MEA 102. These top and bottom views of the MEA 102 depict an active area or catalyst layout 102a and 102ab on each side of the MEA 102, as well as inlet apertures 110l, 112l and 114l and outlet apertures 110r, 112r and 114r designated for distribution of the fuel, oxidant and coolant throughout the electrochemical stack (not shown) which usually comprises a large number of cells. Based on the exemplary embodiment of the MEA 102, the flow field plates 12 and 14 provide a first set of six apertures: two apertures are used for hydrogen gas flow, two apertures are used for oxygen flow and two apertures are used for coolant flow. There may be different embodiments having more or less apertures however there is a one to one correspondence between the apertures in the flow field plates 12 and 14 and the apertures in the MEA 102. For instance, there may be embodiments in which there are no apertures for coolant flow. Accordingly, the MEA 102 has a second set of apertures that correspond to the first set of apertures in the flow field plates 12 and 14.

The MEA 102 may include a plurality of alignment notches 108. These portions of the MEA 102 are not extended in order to accommodate the electrochemical cell stack assembly process in which alignment bars are positioned to coincide with the location of the alignment notches 108 to line up the components of the electrochemical cell assembly 100 with other cells to construct an electrochemical cell stack. The location of the alignment notches 108 may be varied according to the assembly procedure that is used. If a different assembly process is used to construct the electrochemical cell stack, then the alignment notches 108 may be excluded.

The dotted lines 116 and 116b show the perimeter of the conventional MEA 20. As can be seen, the MEA 102 is preferably extended in all directions. Further, the amount of the extension is related to the tolerances of the process used to manufacture the flow field plates 12 and 14 and the MEA 102 and the accuracy of the alignment process. For example, the MEA 102 may be extended by approximately, or at least, 0.5 mm.

In addition, at least one of the inner edges of the MEA 102 along the apertures may also be extended. In the exemplary embodiment of the MEA 102, each of the inner edges of the apertures 110l, 112l, 114l, 110r, 112r and 114r has been extended. Referring now to the top side of the MEA 102, the previous size of the apertures used for the MEA 20 are represented by dotted lines 110l′, 112l′, 114l′, 110r′, 112r′ and 114r′. Accordingly, the cross-sectional areas of the apertures 110l, 112l, 114l, 110r, 112r and 114r are smaller than the cross-sectional areas of the dotted lines 110l′, 112l′, 114l′, 110r′, 112r′ and 114r′. Further, to ensure that shorting is prevented, the centers of the apertures 110l, 112l, 114l, 110r, 112r and 114r may be aligned with the respective centers of the dotted lines 110l′, 112l′, 114l′, 110r′, 112r′ and 114r′.

The amount of extension provided for the inner edges of the apertures 110l, 112l, 114l, 110r, 112r and 114r is also related to manufacturing tolerances and the accuracy of the assembly process. Accordingly, one exemplary value for the amount of extension is approximately, or at least, 0.5 mm. However, the amount of extension of the inner edges of the apertures 110l, 112l, 114l, 110r, 112r and 114r may be adjusted such that the flow of the reactant gas or coolant through the apertures 110l, 112l, 114l, 110r, 112r and 114r is not appreciably affected and the operating efficiency of the fuel cell stack is maintained.

The MEA 102 is useful in situations in which the dimensions of the flow field plates 12 and 14 are not inline with manufacturing specifications such that at least one of the inlet or outlet apertures of both flow field plates 12 and 14 are smaller than intended such that regions of the flow field plates 12 and 14 around these apertures touch. The MEA 202 is also useful in situations in which both of the flow field plates 12 and 14 shift in the same or opposite direction for whatever reason. In both of these situations, with the conventional MEA 20, various regions of the flow field plates 12 and 14 may touch and therefore short. However, in these situations, the extended outer edges of the MEA 102 and/or the extended inner edges of the inlet and outlet apertures of the MEA 102 will separate the flow field plates 12 and 14 from one another to prevent shorting.

It is also known that an MEA can shrink under certain environmental conditions. Accordingly, the apertures may become bigger than intended. This may also result in shorting. The extended edges of the apertures 110l, 112l, 114l, 110r, 112r and 114r of the MEA 102 are quite useful in preventing shorting in this situation.

Referring now to FIG. 2b, shown therein is a magnified view of the electrochemical cell assembly 100 showing a case in which the flow field plate 12 and 14 are bending towards one another. In this case, the flow field plates 12 and 14 do not touch one another since the MEA 102 extends to, as well as possibly past (depending on the size of the enlargement/extension), the edges of the flow field plates 12 and 14. Consequently, the electrical short is prevented for the electrochemical cell assembly 10.

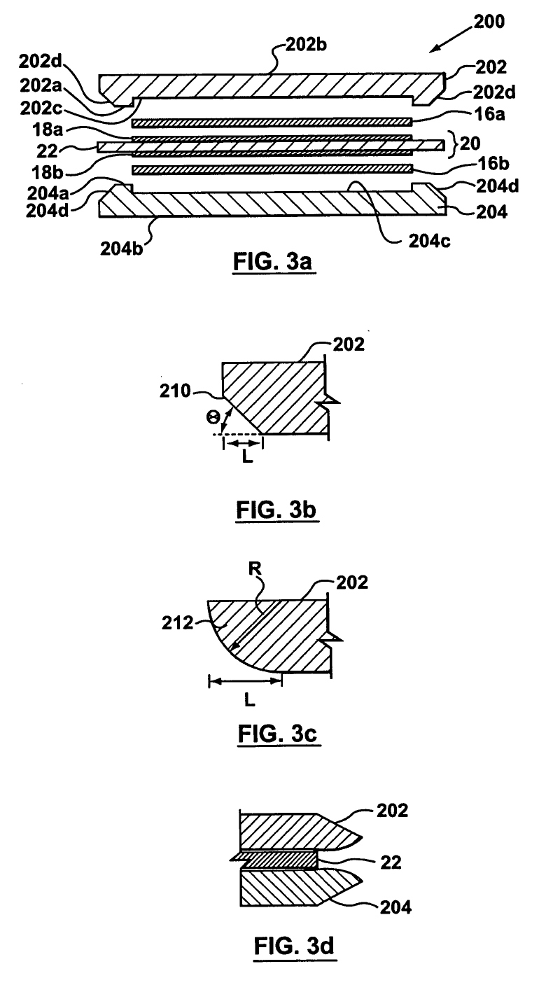

Referring now to FIG. 3a, shown therein is an electrochemical cell assembly 200 constructed in accordance with another embodiment of the invention. The electrochemical cell assembly 200 comprises the same components as the electrochemical cell assembly 10 with alternative shapes for flow field plates 202 and 204. The flow field plates 202 and 204 both have a passive surface 202a and 204b respectively and an active surface 202b and 204a with GDM pockets 202c and 204c However, the flow field plates 202 and 204 also have chamfered edges 202c and 204c on at least one edge of the active surfaces 202a and 204a respectively. The purpose for the chamfered edges 202d and 204d of the flow field plates 202 and 204 is to prevent shorting during the operation of the cell assembly 200 if the flow field plates 202 and 204 bend towards one another for any reason.

At least some of the outer edges of the flow field plates 202 and 204 that are associated with their active surfaces are chamfered. For instance, the outer edges towards which shorting is more prevalent may be preferably chamfered rather than chamfering each outer edge. However, in an alternative embodiment, each outer edge of the flow field plates 202 and 204 may be chamfered. In another alternative embodiment, only one of the flow field plates 202 and 204 has at least some outer edges that may be chamfered.

In a similar fashion, although not shown, at least some of the inner edges of the flow field plates 202 and 204, that are associated with the apertures for providing reactant gas or coolant flow throughout the electrochemical cell stack, may also be chamfered. Similarly to the outer edges, in another alternative embodiment, each of the inner edges of the apertures of the flow field plates 202 and 204 may be chamfered. In another alternative embodiment, only one of the flow field plates 202 and 204 has at least some inner edges that may be chamfered.

Referring now to FIGS. 3b and 3c, using flow field plate 202 as an example, shown therein are magnified views of an inner or outer edge of the flow field plate 202 that has been chamfered in accordance with the invention. With regards to FIG. 3a, the edge of the flow field plate 202 may have a relatively straight chamfer 210. In this case, the straight chamfer is made at a suitable angle θ with respect to the bottom of the flow field plate 202 such that a length L of the bottom of the flow field plate 202 has been removed. Preferably, the length L is chosen according to the tolerance of the manufacturing process used to manufacture the flow field plates 202 and 204 and the MEA 20 as well as the accuracy of the alignment process used to construct the electrochemical cell stack. For example, the length L may be chosen to be approximately or at least 0.5 mm. The angle θ can be chosen to achieve certain values of L while leaving a certain thickness t for the unchamfered portion of the flow field plate 202. A suitable value is chosen for the length L and the angle θ such that the structural integrity of the end of the flow field plate 202 is not compromised. One example of the angle θ is 45 degrees.

With regards to FIG. 3c, the edge of the flow field plate 202 may have a rounded chamfer 212, according to a radius of curvature R that is selected such that the length L of the bottom of the flow field plate 202 has been removed. The radius of curvature R is chosen to provide an appropriate length L based on manufacturing tolerances and assembly alignment accuracy. In one example, the radius of curvature may be approximately 0.051 to 0.18 mm.

The chamfering that is used for the inner and outer edges of a given flow field plate do not have to be of the same type. For instance, it may be beneficial to use straight chamfers for some of the edges of a flow field plate and rounded chamfers for other edges of the flow field plate. This may depend on the amount of stress that a given edge of the flow field plate is under as well as manufacturing ease.

Referring now to FIG. 3d, shown therein is a magnified view of the electrochemical cell assembly 200 showing a case in which the flow field plate 202 and 204 are bending towards one another. In this case, the flow field plates 202 and 204 do not touch one another due to the chamfered edges 202d and 204d (chamfered edges 210 or 212, or some other variation thereof may be used). Consequently, an electrical short is prevented for the electrochemical cell assembly 200.

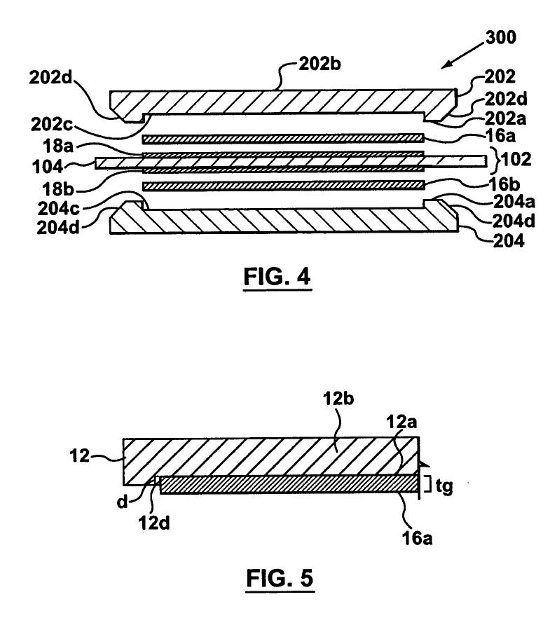

Referring now to FIG. 4, shown therein is a cross-sectional side view of another electrochemical cell assembly 300 in accordance with the invention, which essentially combines features from the electrochemical cell assemblies 100 and 200. The electrochemical cell assembly 300 includes an MEA 102 that extends beyond the perimeter of the flow field plates 202 and 204. In addition, the electrochemical cell assembly 300 includes the chamfered edges 202d and 204d on the active surfaces of the flow field plates 202 and 204 respectively. Since both an extended MEA and chamfered edges are used together to prevent shorting, the amount of extension for the MEA 102 or the degree of chamfering may be relaxed compared to the case in which these two features are used separately.

Although both the extended MEA and the chamfered edges are shown together in embodiment 300, it should be clear that there may be embodiments in which at least one of these features is present. The selection of an extended MEA or chamfered edges or both of these features may depend on the physical size of the stack, i.e. the surface area of the flow field plates and the number of cells in the stack, as well as the operating voltage for the cell stack.

As previously mentioned, the anode and cathode flow field plates 12, 14 usually include a GDM pocket, cavity or depression 12c or 14c for receiving the appropriate GDM 16a and 16b. Referring now to FIG. 5, shown therein, is the GDM pocket 12c on flow field plate 12 for receiving the GDM 16a. The GDM 16a is shown as being uncompressed and having a thickness tg. The GDM pocket 12c has a sufficient depth d for ensuring that the GDM 16a is maintained under a desired amount of compression so that the electrical and gas diffusion properties of the GDM 16a are acceptable. Accordingly, the depth d of the GDM pocket 12c can be set at a certain percentage of the uncompressed thickness of the GDM 16a to achieve optimal performance for the GDM 16a.

In accordance with the invention, the compression applied to the GDM 16a is mostly related to the depth d of the GDM pocket 12d and the uncompressed thickness tg of the GDM 16a. Accordingly, the amount of compression is approximately the difference between the depth d of the GDM pocket 12d and the uncompressed thickness tg of the GDM 16a divided by the uncompressed thickness tg of the GDM 16a. The depth d of the GDM pocket 12d is chosen, and hence the compression set, such that the electrochemical stack is operating at an acceptable level. This may be determined by conducting operational tests and measuring the current through the electrochemical stack and the voltage across the electrochemical stack. This may also be determined by obtaining a polarization curve for the electrochemical stack. In one exemplary case, it was found that for an MEA having a thickness of approximately 0.38 mm uncompressed, an appropriate depth for the GDM pocket 12d was approximately 0.33 mm resulting in a compression of approximately 15%. In this case, the GDM pocket depth is approximately 85 to 86% of the thickness of the GDM uncompressed. In general, the amount of compression required may also depend on the materials used in the MEA 20 and the surface area of the GDM 16a. The pocket depth, and hence the amount of compression, will also depend on the type of GDM that is used since materials vary. In general, the inventors have found that it is advantageous to provide a depth for the GDM pocket 12d such that the amount of compression applied to the GDM 16a is in the range of approximately 10 to 30%.

The invention has been described for electrochemical cells that include flow field plates having a GDM pocket. It should be noted that the various aspects of the invention are also applicable for electrochemical cells that have flow field plates that do not have a GDM pocket. Such electrochemical cells may be used in instances in which the GDM is quite thin (i.e. less than 0.017 inches in thickness). It should be further understood that the invention is also applicable for cases in which an incompressible GDM is used in which case the flow field plates may or may not have a GDM pocket.

While the invention is described in relation to a proton exchange membrane (PEM) fuel cell, it should be understood that the invention has general applicability to any type of fuel or electrochemical cell. Thus, the invention could be applied to: fuel cells with alkali electrolytes; fuel cells with phosphoric acid electrolyte; high temperature fuel cells, e.g. fuel cells with a membrane similar to a proton exchange membrane but adapted to operate at around 200° C.; electrolyzers, and regenerative fuel cells. The invention can also be applied to electrochemical cell assemblies that use gaskets or a seal-in place process to provide sealing. The invention can also be applied to electrochemical cells that use bipolar flow field plates that provide both an anode and a cathode. Further, it should be understood by those skilled in the art, that various modifications can be made to the embodiments described and illustrated herein, without departing from the invention, the scope of which is defined in the appended claims.

1. An electrochemical cell assembly comprising:
a) first and second flow field plates each including an active surface facing one another and having a first surface area;
b) first and second gas diffusion media disposed between the first and second flow field plates; and,
c) a membrane electrode assembly disposed between the first and second gas diffusion media with first and second surfaces each having a second surface area larger than the first surface area, and having at least a portion extending beyond the perimeter of the first and second flow field plates.

2. The electrochemical cell assembly of claim 1, wherein each outer edge of the membrane electrode assembly extends beyond the perimeter of the flow field plates.

3. The electrochemical cell assembly of claim 2, wherein at least one outer edge of the membrane electrode assembly extends beyond the perimeter of the flow field plates by approximately 0.5 mm.

4. The electrochemical cell assembly of claim 1, wherein the first and second flow field plates have a first set of apertures for reactant gas flow and optionally coolant flow, and the membrane electrode assembly has a second set of apertures corresponding to the first set of apertures, wherein at least some inner edges of the apertures in the second set of apertures extend beyond the corresponding inner edges of the apertures in the first set of apertures.

5. The electrochemical cell assembly of claim 4, wherein the at least some inner edges of the apertures in the second set of apertures extend beyond the corresponding inner edges of the apertures in the first set of apertures by approximately at least 0.5 mm.

6. The electrochemical cell assembly of claim 1, wherein the first and second flow field plates have a first set of apertures for reactant gas flow and optionally coolant flow, and the membrane electrode assembly has a second set of apertures corresponding to the first set of apertures, wherein the cross-sectional areas of the apertures in the second set of apertures is smaller than the cross-sectional areas of the corresponding apertures in the first set of apertures.

7. The electrochemical cell assembly of claim 6, wherein the centers of the corresponding apertures in the first and second set of apertures are aligned.

8. The electrochemical cell assembly of claim 1, wherein the membrane electrode assembly comprises a proton exchange membrane and a catalyst layer on each surface of the proton exchange membrane, and wherein a least a portion of the membrane electrode assembly that extends past the edges of the first and second flow field plates includes a catalyst layer.

9. The electrochemical cell assembly of claim 1, wherein the active surface of at least one of the flow field plates includes at least one chamfered edge.

10. The electrochemical cell assembly of claim 9, wherein the at least one chamfered edge is a straight chamfer.

11. The electrochemical cell assembly of claim 9, wherein the at least one chamfered edge is a round chamfer.

12. The electrochemical cell assembly of claim 9, wherein the at least one chamfered edge is chamfered such that approximately at least 1 mm of the edge of the inner surface of the at least one flow field plate is removed.

13. The electrochemical cell assembly of claim 1, wherein the active surface of each flow field plate includes a pocket for receiving one of the first and second gas diffusion media, the pocket having a depth that is less than the thickness of the gas diffusion media when uncompressed.

14. The electrochemical cell assembly of claim 1, wherein the pocket has a depth for applying a compression force of approximately 10 to 30% on the gas diffusion media.

15. An electrochemical cell assembly comprising:
a) first and second flow field plates, each including an active surface facing one another;
b) first and second gas diffusion media disposed between the first and second flow field plates; and,
c) a membrane electrode assembly disposed between the first and second gas diffusion media, wherein the active surface of at least one of the flow field plates includes at least one outer chamfered edge.

16. The electrochemical cell assembly of claim 15, wherein the at least one outer chamfered edge is a straight chamfer.

17. The electrochemical cell assembly of claim 15, wherein the at least one outer chamfered edge is a round chamfer.

18. The electrochemical cell assembly of claim 15, wherein the at least one outer chamfered edge is chamfered such that at least approximately 1 mm of the edge of the active surface of the at least one flow field plate is removed.

19. The electrochemical cell assembly of claim 15, wherein the at least one of the flow field plates includes apertures for reactant gas flow and optionally coolant flow, wherein at least one of the apertures has at least one inner chamfered edge.

20. The electrochemical cell assembly of claim 19, wherein the at least one inner chamfered edge is a straight chamfer.

21. The electrochemical cell assembly of claim 19, wherein the at least one inner chamfered edge is a round chamfer.

22. The electrochemical cell assembly of claim 19, wherein the at least one inner chamfered edge is chamfered such that at least approximately 1 mm of the edge of the active surface of the at least one flow field plate is removed.

23. The electrochemical cell assembly of claim 15, wherein the active surface of each flow field plate includes a pocket for receiving one of the first and second gas diffusion media, the pocket having a depth that is less than the thickness of the gas diffusion media when uncompressed.

24. The electrochemical cell assembly of claim 19, wherein the pocket has a depth for applying a compression force of approximately 10 to 30% on the gas diffusion media.

25. An electrochemical cell assembly comprising:
a) first and second flow field plates each including an active surface facing one another and having a first surface area, the first and second flow field plates having a first set of apertures for reactant gas flow and optionally coolant flow;
b) first and second gas diffusion media disposed between the first and second flow field plates; and,
c) a membrane electrode assembly disposed between the first and second gas diffusion media, with first and second surfaces each having a second surface area larger than the first surface area and having at least a portion extending beyond the perimeter of the first and second flow field plates, and wherein the membrane electrode assembly has a second set of apertures corresponding to the first set of apertures, wherein at least some inner edges of the apertures in the second set of apertures extend beyond the corresponding inner edges of the apertures in the first set of apertures.

26. A flow field plate for an electrochemical cell assembly, the flow field plate having an active surface, and apertures for reactant gas flow and optionally coolant flow, wherein the active surface has at least one outer chamfered edge and at least one of the apertures has at least one inner chamfered edge.
